(19) United States
(12) Patent Application Publication
(10) Pub. No.: US 2008/0133512 A1
(43) Pub. Date: Jun. 5, 2008

(54) User Name Generation

(75) Inventors: Kirk R. Myhre, Redmond, WA (US); Emmanuel Jose Miranda-Steiner, Redmond, WA (US); Michael C. Kunz, Seattle, WA (US); Jameelah-Dosiah T. Sharrieff-Ayedun, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/565,354

(22) Filed: Nov. 30, 2006

(51) Int. Cl. G06F 17/21

(52) U.S. Cl. 707/6

(57) ABSTRACT

User name generation techniques are described. In an implementation, one or more words are received to be used as a user name to access a resource. One or more characters of at least one of the words are modified such that the word having the one or more modified characters is available as a user name.

### BACKGROUND

User names are employed by a variety of different resources for a variety of different purposes. For example, users may employ user names to participate in instant messaging sessions to differentiate between the users, may employ user names to access resources over a network (e.g., online banking, email, travel websites, and so on), may employ user names to gain access to local resources (e.g., a personal computer, mobile phone), and so on.

A network service, for instance, may specify that each user that accesses the service is to have a unique user name, such as to provide resources specific to each of the users. However, a multitude of users may access that same resource. Therefore, the user names that are available may continue to diminish as more and more users continue to be added to the service. Consider an email service, for instance, in which users numbering in the hundreds of millions access the service to send and receive email. This sheer quantity of users that access the service may make determination of a unique user name by subsequent users a lengthy and frustrating task, which may even result in the users forgoing access to the service altogether.

### SUMMARY

User name generation techniques are described. In an implementation, one or more words are received to be used as a user name to access a resource. One or more characters of at least one of the words are modified such that the word having the one or more modified characters is available as a user name. The modifications may be performed in a variety of ways, such as to change one character to another, split a word into additional words, use a thesaurus lookup for similar words, and so on. Further, these modifications may be performed in real time as the characters and/or words are entered by a user to give real time feedback.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques to generate user names.

FIG. 2 is an illustration of an exemplary implementation of a user interface of FIG. 1 that is configured to generate a user name.

FIG. 3 depicts an exemplary implementation of a user interface of FIG. 2 in which user name suggestions are output in response to input of characters by a user.

FIG. 4 depicts an exemplary implementation of a user interface of FIG. 3 in which additional user name suggestions are output in response to receipt of additional inputs from a user.

FIG. 5 is a flow diagram depicting a procedure in an exemplary implementation in which words which are to be used to base a user name are modified to arrive at one or more user name suggestions that are available to access a resource.

### DETAILED DESCRIPTION

Overview

User names, as previously described, may be utilized to access a vast number of resources for a variety of different purposes. Traditional techniques that were used to create user names, however, relied on the user entering potentially unique names, one at a time, and checking their availability after each one. This laborious and potentially frustrating process may therefore hinder the users from even accessing the resource altogether.

A user, for example, using traditional techniques may enter a word “bunny” into a user name box for a particular domain, e.g., “serviceprovider.com”. The user may then click a “check availability” box to determine if that name is available. If not, the user may then enter the words “bluebunny” into the user name box and again select the “check availability” box. If that name is not available, the user may enter the term “bigbluebunny” into the user name box and yet again select the “check availability” box. If available, a message may be displayed indicating this availability. As is readily apparent, this process may become frustrating when hundreds of millions of users access the resource, each having a unique user name.

Accordingly, techniques are described to generate user names. In an implementation, a technique is described in which modifications to one or more words supplied by a user are made to generate a user name that is available for use by the user. Following the previous example, for instance, a user may input the word “bluebunny”. A system may determine that although this combination is not available, the user name “blue_bunny” is available by splitting the Word. The system may also determine that “bluerabbit” is available through use of a thesaurus. Further, the suggested user names may be output in real time as the user enters the desired words and even characters within the words. A variety of other examples are also contemplated, further discussion of which may be found in the following discussion.

In the following discussion, an exemplary environment is first described that is operable to perform techniques to generate user names. Exemplary procedures and user interfaces are then described that may be employed in the exemplary environment, as well as in other environments.

### EXEMPLARY ENVIRONMENT

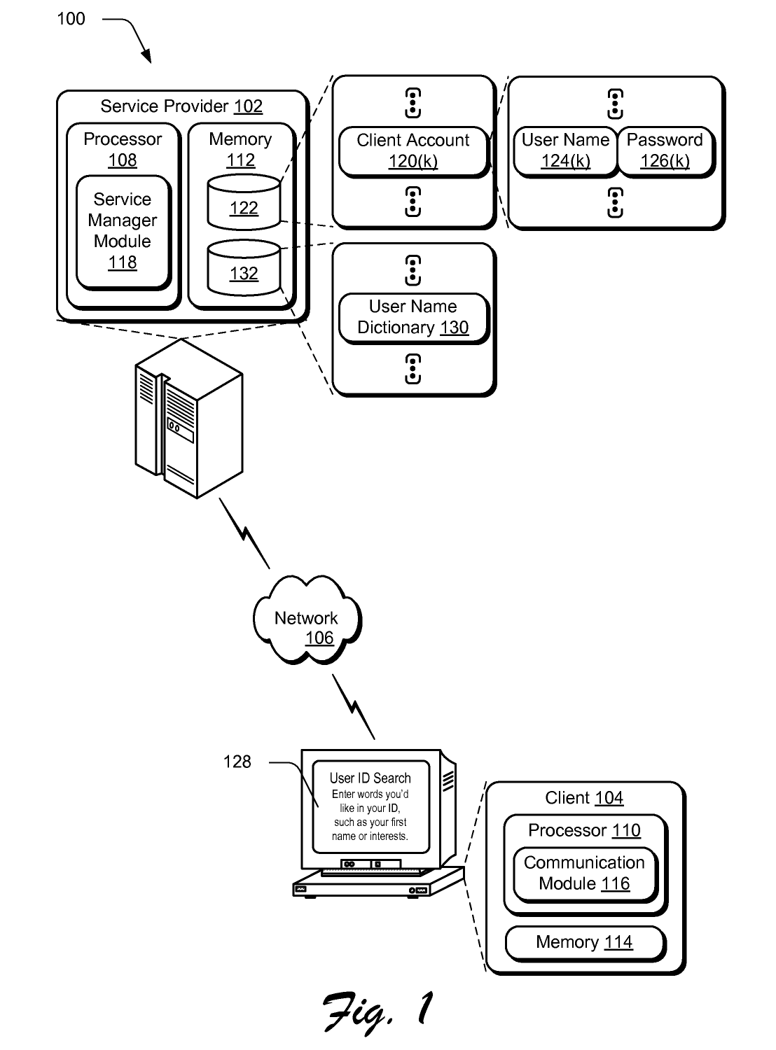

FIG. 1 is an illustration of an environment 100 in an exemplary implementation that is operable to employ user name generation techniques. The illustrated environment 100 includes a service provider 102 and a client 104 that are communicatively coupled, one to another, via a network 106. In the following discussion, the service provider 102 and the client 104 may be representative of one or more entities, and therefore reference may be made to a single entity (e.g., the client 104) or multiple entities (e.g., the clients 104, the plurality of clients 104, and so on).

The clients 104 may be configured in a variety of ways for network 106 access. For example, one or more of the clients 104 may be configured as a computing device, such as a desktop computer, a mobile station, an entertainment appliance, a set-top box communicatively coupled to a display device, a wireless phone, a game console, and so forth. Thus, the clients 104 may range from full resource devices with substantial memory and processor resources (e.g., personal computers, game consoles) to low-resource devices with limited memory and/or processing resources (e.g., traditional set-top boxes, hand-held game consoles). The clients 104, in portions of the following discussion, may also relate to a person and/or entity that operate the clients. In other words, one or more of the clients 104 may describe logical clients that include users, software, and/or devices.

The service provider 102 is illustrated in FIG. 1 as being implemented by a server and the client 104 is illustrated as a client device, each of which having respective processors 108, 110 and memory 112, 114. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 112, 114 is shown, respectively, for the service provider 102 and the client 104, a wide variety of types and combinations of memory may be employed, such as random access memory (RAM), hard disk memory, removable medium memory, and other types of computer-readable media.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The client 104 is illustrated as executing a communication module 116 on the processor 110, which is also storable in memory 114. The communication module 116 is representative of an executable module that is configured to communicate with the service provider 102 over the network 106. For example, the communication module 116 may be configured as a web browser that allows the client 104 to “surf” the Internet. In another example, the communication module 116 is configured as a “smart” client module that is configured to provide other network functionality as a part of its operation, such as an instant messaging module, an email module, an online banking module, and so on. A wide variety of other examples are also contemplated.

Through use of the communication module 116 in the environment of FIG. 1, the client 104 may access a variety of resources provided by the service provider 102 through execution of a service manager module 118. Thus, the service manager module 118 of FIG. 1 is representative of functionality to provide resources over a network 106 to the client 104, such as email services, content, instant messaging, web pages, “spaces”, online banking, and so on. To access these resources, the service manage module 118 may manage one or more client accounts 120(k) (where “k” can be any integer from one to “K”) which are illustrated as stored in storage 122 in the memory 112 of the service provider 102.

Each client account 120(k) in the environment 100 of FIG. 1 is illustrated as being associated with a user name 124(k) and password 126(k), which may be used in association with the services provided by the service provider 102. For example, the user name 124(k) and password 126(k) may be used to access an email account, identify that user to other users, and so on. It should also be noted that in some instances a password 126(k) is not associated with the user name 124(k).

To generate the user names, the client 104 (through execution of the communication module 116) may interact with the service provider 102, such as the service manager module 118. The service manage module 118, for instance, may provide a utility to generate user names that may be used to interact with the service provider 102 and/or another service provider. For example, the client 104 may access the service provider 102 and be presented with a user interface 128 that instructs the user to enter one or more words that may be incorporated within the user name. If that user name is not available (e.g., the user name is already being used or is blocked from being used), the service manager module 118 may make one or more user name suggestions of user names that are available based on the input words.

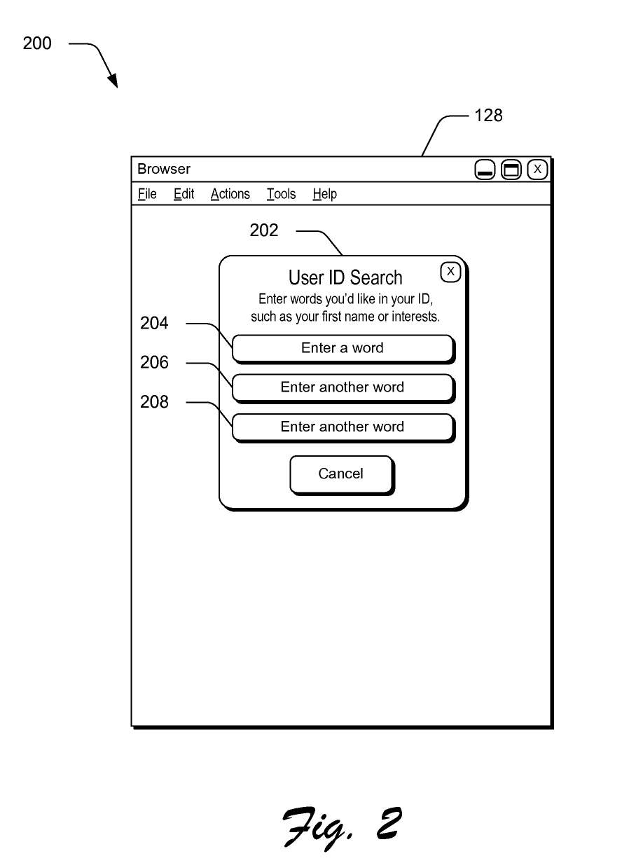

For example, a user name dictionary 130 may be queried from storage 132 in the memory 112 to determine similar words or phrases that may be used instead of the supplied terms, such as through a thesaurus lookup. The user name dictionary 130 may also be used to present abbreviations, acronyms and so on based on the entered words, such as to suggest “blubunny” for the desired words “blue” and “bunny”. Further, the functionality to suggest user names may split and combine words, such as to split “trueblue” into “true_blue”, combine words “blue” and “bunny” into “bluebunny”, and so forth. Yet further, the functionality may present a larger set of potential choices by automatically generating a list of available user names across multiple domains, such as “blue_bunny@hotmail.com” and “bluebunny@live.com”. Thus, the functionality may provide a variety of suggestions to a user without forcing the user to engage in the previous trial and error process to locate a desirable user name. Further, this functionality may be performed in real time to provide feedback as the user enters words and characters, further discussion of which may be found in relation to FIGS. 2-4.

Although the previous examples described use of user names to access resources over a network, it should be readily apparent that this functionality may also be incorporated to access local resources, such as resources contained on the client 104 itself, without departing from the spirit and scope thereof.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory 112, 114. The features of the techniques to generate user names described below are platform-independent, meaning that the techniques may be implemented on a variety of commercial computing platforms having a variety of processors.

FIG. 2 is an illustration of an exemplary implementation 200 of the user interface 128 of FIG. 1 which is usable to generate a user name. The illustrated user interface 128 in FIG. 2 is shown as being provided by a browser. The user interface 128 includes an overlay 202 that is usable to enter characters, which may be words that include alphabetic, numeric and/or symbolic (e.g., “@”, “$”) characters.

The overlay 202, as illustrated, includes a plurality of portions 204, 206 and 208, each of which is configured to accept one or more characters. The characters entered via the portions may be utilized to suggest user names, such as by changing characters, splitting and/or combining words, and so on as previously described. In an implementation, suggestions are output that are available, at the time of suggestion, for use as a user name to access the resource. In other words, the suggestions may be “checked” before output to determine if they are available, and if not, further suggestions may be generated and “checked” before output.

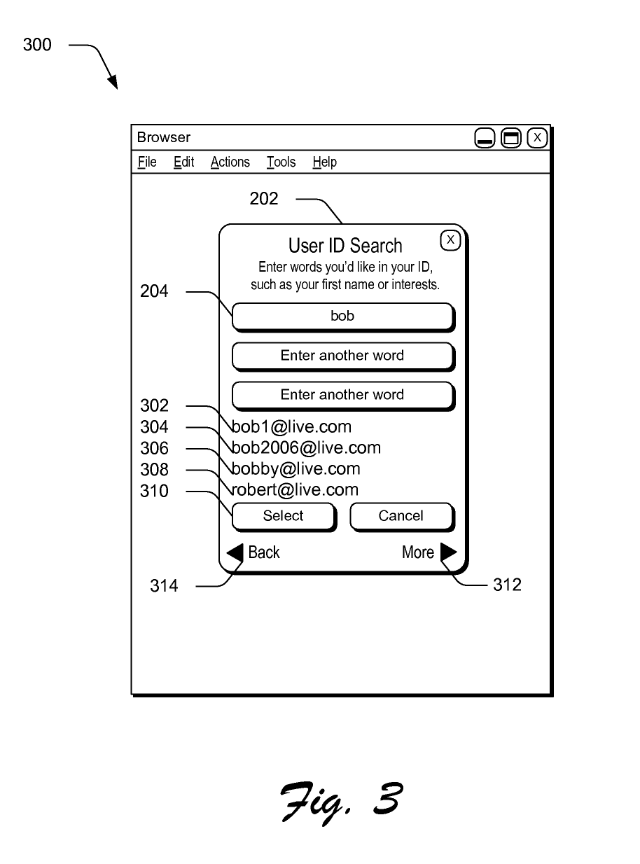

As shown in FIG. 3, for instance, an exemplary implementation 300 of the user interface 128 of FIG. 2 is shown in which user name suggestions are output in response to input of characters by a user. As illustrated in FIG. 3, a user has entered characters forming the word “bob” in the portion of the overlay 202. As the word “bob” is entered, a plurality of user name suggestions 302, 304, 306 and 308 are also output in the overlay 202, which are illustrated as “bob1@live.com”, “bob2006@live.com”, “bobby@live.com” and “robert@live.com”, respectively.

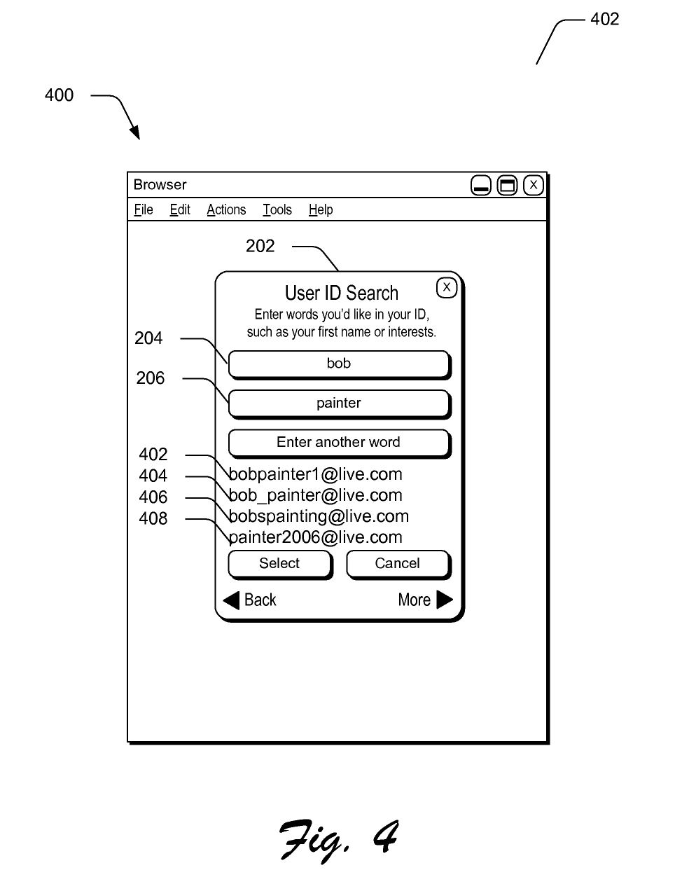

The user may then choose one of the suggestions that are desirable, such as by highlighting the desired suggestion and “pressing” the “select” button 310. The overlay 202 may also include navigation functionality, such as “more” 312 and “back” 314 buttons to navigate through additional selections if the currently displayed suggestions are not desirable. If none of the suggestions are desirable, the user may continue to add additional terms, an example of which is shown in FIG. 4.

FIG. 4 depicts an exemplary implementation 400 of the user interface 128 of FIG. 3 in which additional user name suggestions are output in response to receipt of additional inputs from a user. In the illustrated exemplary implementation 400, the user has continued to enter characters into additional portions of the overlay 202, in this instance the word “painter” has been entered into portion 206. These characters may also be used to generate user name suggestions, in combination with or apart from previously entered characters.

User name suggestions 402, 404 and 406, for instance, are illustrated as “bobpainter1@live.com”, “bob_painter@live.com” and “bobspainting@live.com”, respectively, and therefore each of these suggestions incorporate aspects of character entered in both portions 204, 206. User name suggestion 408, however, is illustrated as “painter2006@live.com” and therefore uses characters from portion 206 but not from portion 204 to make the suggestion. In this way, “simplified” suggestions may still be provided even when multiple words are provided. A variety of techniques may be used to make the suggestions, further discussion of which may be found in relation to the following exemplary procedures.

### EXEMPLARY PROCEDURES

The following discussion describes user name generation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interfaces of FIGS. 2-4.

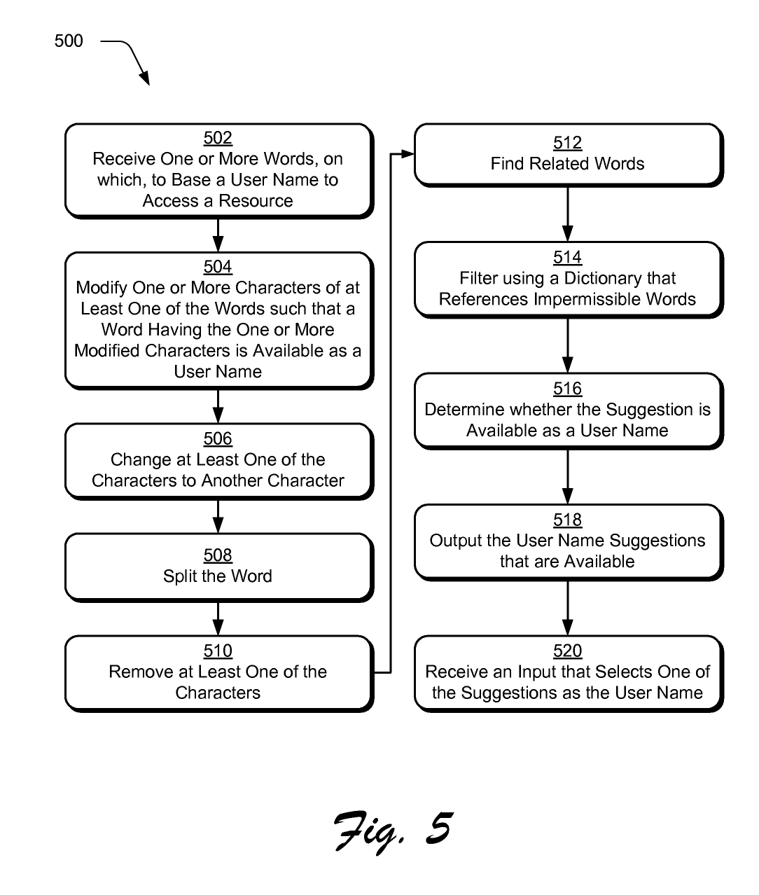

FIG. 5 depicts a procedure 500 in an exemplary implementation in which words which are to be used to base a user name are modified to arrive at one or more user name suggestions that are available to access a resource. One or more words are received, on which, to base a user name to access a resource (block 502). The words, for instance, may be entered by a user when interacting with the overlay 202 depicted in FIGS. 2-4 such that each word is entered separately in different portions 204-208 of the overlay 202. In another example, the one or more words are entered in a continuous string in a single portion of an overlay. A variety of other examples are also contemplated.

One or more characters of at least one of the words are modified such that a word having the one or more modified characters is available as a user name (block 504). The modifications may be performed in a variety of ways. For example, at least one of the characters in the word may be changed to one or more other characters (block 506). The service provider 102, for example, may change a word to an alternate spelling.

In another example, the word may be split (block 508). For instance, the word “bluepainter” may be received but is not available as a user name. However, the user name “blue_painter” may be available and therefore provided as a suggestion. A variety of punctuation may be used to “split” words, including dashes and so on.

In yet another example, at least one of the characters may be removed (block 510). The word “blue” for instance, may be changed to the word “blu”, such as to be used in “blupainter”.

In a further example, related words may be found (block 512). The service provider, for instance, may search a thesaurus for synonyms, antonyms, and so on of a word provided by a user.

The suggestions may then be filtered using a dictionary that references impermissible words (block 514). The dictionary, for instance, may indicate that the username “accountmanager” is not available, filter for profanity or disparaging names, and so on.

A determination may then be made as to whether the suggestions are available as a user name (block 516). The service provider 102, for instance, may check each of the suggestions with currently used user names 124(k) of client accounts 120(k) to ascertain whether they are currently being utilized. The user name suggestions that are available may then be output (block 518) such that an input may be received from a user to select one of the suggestions as the user name (block 520). In this way, suggestions that are currently available at the time of the determination may be output, thereby reducing and even eliminating the “back-and-forth” guessing that was encountered using traditional techniques. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A computer-implemented method comprising:
receiving one or more words, on which, to base a user name to access a resource (502); and
modifying one or more characters of at least one said word such that the word having the one or more modified characters is available as a user name (504).

2. A computer-implemented method as described in claim 1, wherein each said word is a collection of at least one of alphabetic or numeric characters.

3. A computer-implemented method as described in claim 1, wherein the modifying is performed in real time as each of the one or more said words is received.

4. A computer-implemented method as described in claim 1, wherein the modifying includes splitting the at least one said word.

5. A computer-implemented method as described in claim 1, wherein the modifying includes removal of at least one said character from the at least one said word.

6. A computer-implemented method as described in claim 1, wherein the modifying includes changing at least one said character to another character in the at least one said word.

7. A computer-implemented method as described in claim 6, wherein the modifying includes determining whether the at least one said word having the changed at least one said character is available to be used in a user name to access the resource.

8. A computer-implemented method as described in claim 1, further comprising outputting a plurality of said words having the one or more changed characters as user name suggestions, each of which being selectable as a user name to access the resource.

9. One or more computer readable media comprising computer executable instructions that, when executed, direct a computer to output user name suggestions as one or more inputs are received that specify a user name to be used to access a resource.

10. One or more computer readable media as described in claim 9, wherein the outputting is performed in real time as the one or more inputs are received.

11. One or more computer readable media as described in claim 9, wherein:
the one or more inputs are received as a string of characters; and
the user name suggestions are output as the characters are received individually in the string.

12. One or more computer readable media as described in claim 9, wherein:
the one or more inputs are received over a network from a client; and
the resource is a network service provided by a network service provider over the network to the client.

13. One or more computer readable media as described in claim 9, wherein each said user name suggestion is available to be used as a user name to access the resource when output.

14. One or more computer readable media as described in claim 9, wherein the output user name suggestions are filtered using a list of words that are not permitted to be included in user names of the resource.

15. One or more computer readable media as described in claim 9, wherein at least one said user name suggestion is created by modifying a word specified by the one or more inputs.

16. One or more computer-readable media comprising executable instruction that, when executed, direct a computer to output a user interface having a plurality of portions, each being configured to accept one or more characters to be used to form a user name employable to access a resource.

17. One or more computer-readable media as described in claim 16, wherein the computer executable instructions further direct the computer to make user name suggestions based on the characters received via the plurality of portions, wherein each said suggestion is employable, when made, as a user name to access the resource.

18. One or more computer-readable media as described in claim 17, wherein the user name suggestions are made in real time.

19. One or more computer-readable media as described in claim 16, wherein the computer executable instruction direct the computer to make user name suggestions by modifying at least one of the characters entered via at least one of the portions.

20. One or more computer-readable media as described in claim 16, wherein the computer executable instruction direct the computer to make user name suggestions by querying a thesaurus using a word input via one or more of the portions.
